(19) United States
(12) Patent Application Publication
(10) Pub. No.: US 2017/0333886 A1
(43) Pub. Date: Nov. 23, 2017

(54) METAL-INORGANIC FRAMEWORKS

(71) Applicant: University of North Texas, Denton, TX (US)

(72) Inventors: Mohammad A. Omary, Denton, TX (US); Joshua F. Ivy, Denton, TX (US)

(21) Appl. No.: 15/587,053

(22) Filed: May 4, 2017

Related U.S. Application Data
(60) Provisional application No. 62/332,292, filed on May 5, 2016.

(51) Int. Cl. B01J 31/16; B01J 31/18; B01J 31/22

(52) U.S. Cl. CPC B01J 31/1691; B01J 31/2252; B01J 31/1845; B01J 31/1805; B01D 2253/311; B01D 2253/308

(57) ABSTRACT

Metal-inorganic frameworks (“MIFs”) having enhanced adsorption capabilities to hydrogen, CO, CO₂, hydrocarbons, and a variety of other guest molecules are disclosed. All linkers in the MIFs contain metal complexes, comprising metal atoms and inorganic or organic ligands, instead of only organic ligands as linkers in metal-organic frameworks (MOFs). Compared to their MOF counterparts, MIFs with carbon-free or carbon-deficient chemical structure are expected to possess enhanced thermal stability, higher catalytic activity, and higher gas affinity and selectivity.

### CROSS-REFERENCE TO RELATED APPLICATION

The present application claims the benefit of U.S. Provisional Patent Application No. 62/332,292, filed on May 5, 2017, the contents of which are incorporated herein by reference in its entirety.

### FIELD OF THE INVENTION

This invention relates to the fields of inorganic chemistry, structured inorganic frameworks, and gas adsorption and storage.

### BACKGROUND

Porous materials with an inorganic, organic, or a metal-organic framework (“MOF”), can be used in a range of applications. These include size- and shape-selective catalysis, separations, gas storage, ion-exchange, sensors, and optoelectronics. In particular, stable MOFs with permanent highly-porous channels or cavities have been explored as effective, economic, and safe on-board vehicular gas (hydrogen or methane) storage materials for fuel-cell-driven automobiles, CO₂ capture and/or storage, gas separation, sensing and/or remediation of hazardous gases or liquids, etc.

Extensive efforts have been devoted to the rational design and construction of new MOFs with zeolite-like, well-defined, stable, and extra-large micro- or meso-size pore channels exhibiting higher or selective gas affinity properties. Pioneered by Yaghi et al., a vast number of organic ligands with a variety of donor groups and over 40 metal cations have been explored in MOF construction (Yaghi, et al. 1995). Metal-inorganic frameworks (MIFs), on the other hand, represent a new concept whereby metal atoms or clusters are connected by inorganic complexes to organic molecules.

High volumetric capacity is an important property for gas storage applications. Particularly for H₂ and CH₄ storage in automobiles, the volumetric capacity is arguably more important than the gravimetric capacity. Due to their high porosity, the best MOFs known to date have disappointingly low densities (e.g., 0.43, 0.51, and 0.62 g/mL) leading to low H₂ and CH₄ volumetric uptake (Wong-Foy, et al. 2006; Dinca, et al. 2006) with a few exceptions (e.g., Feng, et al. 2014). Due to the additive size of the metal, inorganic or organic ligand, and ligand substituents within their inorganic complex linker, MIFs offer the potential to achieve significantly higher and more efficient hydrogen uptake and volumetric storage capacity than MOFs do at both cryogenic and near-ambient temperatures.

Nanostructured carbon materials (e.g., carbon nanotubes, graphite nanofibers, activated carbon, and graphite) and porous MOFs have become of interest to researchers as potential hydrogen adsorbents. However, it has been shown that nanostructured carbons have slow uptake, exhibit irreversible adsorption, and contain reduced transition metals as impurities. Meanwhile, known MOFs have low volumetric H₂ uptake due to their low densities and weak affinity to hydrogen molecules. In addition, the porous nature and high surface areas of MOFs give rise to rather weak H₂ adsorption energies (˜5 kJ/mol).

Oil, natural gas, and petroleum products (hydrocarbons) are some of the most important energy sources in the world. As long as oil is prospected, transported, stored, and used, there will be a risk of spillage that may result in significant environmental damage and vast economic loss. It is estimated that the oil spill clean-up costs worldwide amount to over $10 billion dollars annually. The adverse impacts to ecosystems and the long-term effects of environmental pollution by these and other releases call for an urgent need to develop a wide range of materials for cleaning up oil from impacted areas, especially because the effectiveness of oil treatment varies with time, type of oil and spill, location and weather conditions. There are many adsorbents in use for oil spill cleanup, including sand, organo-clays and cotton fibers. These adsorbents, however, have strong affinity to water, limiting their effectiveness in cleanup operations. Therefore, the development of waterproof sorbents that are effective even at very low concentrations of oil residue remains an urgent challenge.

MOFs are promising adsorbents for many guest molecules, although reports concerning adsorption of hydrocarbons (organic vapor) in MOFs remain scarce compared to their H₂, CO₂, CO, and inert gas adsorption. Thus, the search for MOF and MIF materials with the desirable combination of good thermal stability, high selectivity, and excellent recyclability is a major challenge and of great technological importance for oil spill cleanup, hydrocarbon storage in a solid matrix to allow transportation in smaller and safer vehicles, catalysis, water purification, component and isomer separation from gasoline mixtures, and environmental remediation of greenhouse gases.

### SUMMARY

A solution to the disadvantages of the currently available metal organic frameworks has been discovered. In particular, the solution is based on a surprising discovery that inorganic complexes may be used as linkers for metal atoms or clusters.

Disclosed herein are metal-inorganic frameworks (MIFs) and methods for synthesizing the same. In some embodiments, the MIFs are carbon-free MIFs. In some embodiments, the MIFs comprise a plurality of metal clusters and a plurality of linking complexes. Each metal cluster may comprise one or more metal ions, in some aspects. The MIF metal ions include, but are not limited to Cu²⁺, Pt²⁺, Pd²⁺, Zr⁴⁺, Zn²⁺, Ni²⁺, Mn²⁺, or a combination thereof In some aspects, the MIFs disclosed herein possess a variety of low-dimensional (linear, trigonal-planar, square-planar, macrocyclic-planar, oligomeric clusters of all the above, and/or 2-dimensional infinite-sheet assemblies of all the above) geometries.

In some embodiments, a linking complex may comprise a linear/two-coordinate, trigonal planar/three-coordinate, or square planar/four-coordinate geometries. In some embodiments, a MIF comprises a combination of linking complexes of different geometric arrangements. In some aspects, the linking complexes are oligomeric or polymeric associative linker aggregates. Non-limiting examples of linking complexes include a [Pt₂(P₂O₅H₂)]⁴⁻ dimeric four-coordinate/square planar complex linker, a trinuclear gold(I) two-coordinate/linear complex linker, and a [Au(TPPTS)₃]⁸⁻ three-coordinate/trigonal planar complex linker.

In some aspects, a MIF has one or more cavities suitable for containing or storing one or more gas molecules. In some embodiments, a MIF has an average pore size of between 1 Å and 50 Å. In specific embodiments, a MIF has an average pore size of about 10 Å. The MIF surface area may be measured by the Brunauer-Emmett-Teller (BET) method. In some aspects, a MIF has a surface area of at least about 80 m²/g as measured by the BET method. In other aspects, a MIF has a surface area of at least about 250 m²/g as measured by the BET method. In some embodiments, the MIF has a pore volume of 0.13 cm³/g. In particular aspects, the MIF has a maximum pore volume of 0.1325 cm³/g.

In some aspects, a method of storing a gas within a MIF is disclosed. The method comprises contacting a MIF having an average pore size of 10 Å with a gas. In some embodiments, the gas storage temperature is room temperature. In further embodiments, the temperature is below room temperature. In further embodiments, the temperature is 50, 55, 60, 65, 70, 75, 80, 85 K, or any temperature therein. In yet further embodiments, the temperature is 77 K. In some embodiments, the gas is stored at ambient pressure. In other embodiments, the gas is stored at a pressure that is above or below ambient pressure. In further embodiments, the gas is stored at a pressure of up to 50 bar. In some aspects, the MIF is carbon-free. In some embodiments, the gas is hydrogen, carbon monoxide, carbon dioxide, a hydrocarbon, or nitrogen.

In some aspects, a MIF of the present disclosure may be used for oil spill cleanup, catalysis, water purification, environmental remediation of greenhouse gases, component and isomer separation from gasoline mixtures, storage of gases, including but not limited to hydrocarbons, carbon monoxide, carbon dioxide, hydrogen, nitrogen, oxygen, ammonia, chlorine, a noble gas, hydrogen sulfide, or a solvent vapor.

Any method or system of the present invention can consist of or consist essentially of—rather than comprise/include/contain/have—any of the described elements and/or features and/or steps. Thus, in any of the claims, the term “consisting of” or “consisting essentially of” can be substituted for any of the open-ended linking verbs recited above, in order to change the scope of a given claim from what it would otherwise be using the open-ended linking verb.

Throughout this application, the term “about” is used to indicate that a value includes the standard deviation of error for the device and/or method being employed to determine the value.

The term “substantially” is defined as being largely but not necessarily wholly what is specified (and include wholly what is specified) as understood by one of ordinary skill in the art. In any disclosed embodiment, the term “substantially” may be substituted with “within [a percentage] of” what is specified, where the percentage includes 0.1, 1, 5, and 10 percent.

As used herein, in the specification, “a” or “an” may mean one or more, unless clearly indicated otherwise. As used herein, in the claim(s), when used in conjunction with the word “comprising,” the words “a” or “an” may mean one or more than one. As used herein “another” may mean at least a second or more.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 demonstrates the building blocks of the carbon-free MIF series MIF-1 through MIF-4.

FIGS. 2A-2C. FIG. 2A depicts a reaction scheme for building blocks of a MIF-II series (M=Pt²⁺), a MIF-III series (M=Pd²⁺), and a MIF-IV series (M=Ni²⁺), and MIF-V series (M=Cu²⁺). FIG. 2B depicts a reaction scheme for the synthesis of a 5-(pyridine-2-yl)-4H-1,2,4-triazole-3-carboxylic acid ligand. The ligand coordinates to the M linker in FIG. 2A with R=COOH. FIG. 2C depicts a reaction scheme for the synthesis of a 4-(5-(pyridine-2-yl)-4H-1,2,4-triazol-3-yl) benzoic acid ligand. The ligand coordinates to the M linker in FIG. 2A with R=p-C₆H₄-COOH. Sub-series are defined by x for the linker's metal M, AB for the R group, and number for the second metal M′; e.g., “MIF-III-B-1” denotes the sub-series with M=Pd²⁺, R=COOH, and M′=Zr⁴⁺

FIG. 3 illustrates building blocks of the MIF-VI series (top: representative embodiments MIF-VI-1 through MIF-VI-4) and the MIF-VII series (bottom: MIF-VII-A through MIF-VII-C).

FIG. 4 illustrates building blocks of the MIF-VIII series MIF-VIII-1 through MIF-VIII-4.

FIGS. 5A-5B. FIG. 5A is a plot of nitrogen adsorption isotherms at 77 K for MIF-1 (BET surface area=266.5 m²/g; approximate pore size=10 Å). FIG. 5B is a plot of nitrogen adsorption isotherms at 77 K for MIF-4 (BET surface area=86.3 m²/g).

FIGS. 6A-6C. FIG. 6A is an image of MIF-1, MIF-2, and NaPtPOP starting material/precursor. FIG. 6B is an image illustrating enhancements in the photoluminescence quantum yield. MIF-1=1045% enhancement vs Na₄[Pt(POP)₄] control. MIF-2=610% enhancement vs Na₄[Pt(POP)₄] control. FIG. 6C is an image illustrating stability upon extended storage in air for MIF-1 and MIF-2 vs the NaPtPOP starting material/precursor as a control.

FIG. 7 is a graph of the solid-state absorption spectra for MIF-3 and MIF-4 vs MIF-1 along with photographs of each solid sample at ambient room light.

FIGS. 8A-8C. FIG. 8A illustrates the linear geometry of a 2-coordinate MIF linker. FIG. 8B illustrates the trigonal geometry of a 3-coordinate MIF linker. FIG. 8C illustrates the square-planar geometry of a 4-coordinate MIF linker.

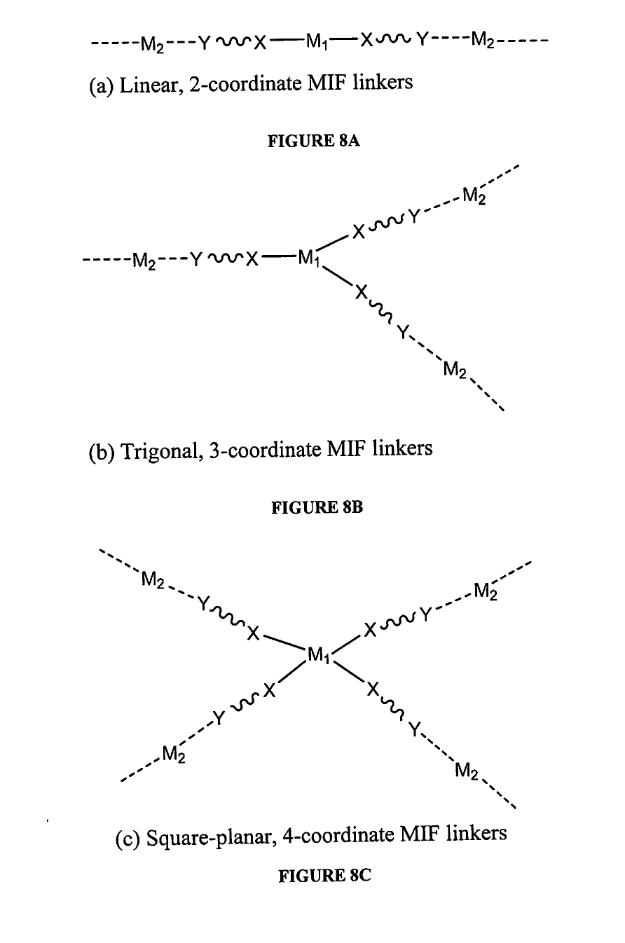

### DETAILED DESCRIPTION

Currently available MOFs are lacking with respect to thermal stability, catalytic activity, gas affinity, and gas selectivity. This leads to performance and cost inefficiencies when using such membranes in applications such as hydrogen gas storage.

It has now been discovered that inorganic complexes may be used to synthesize porous frameworks. The metal-inorganic frameworks possess enhanced thermal stability, higher catalytic activity, and higher gas affinity and selectivity.

Disclosed herein is a new class of porous materials and coordination polymers called “metal-inorganic frameworks” or “MIFs” having internal channels and cavities in a variety of configurations that are capable of adsorbing small guest molecules. The MIFs are connected by inorganic complexes instead of organic molecules as linkers or building blocks.

The MIFs disclosed herein possess a variety of low-dimensional linear, trigonal-planar, square-planar, and/or macrocyclic-planar oligomeric clusters and 2-dimensional infinite-sheet assembly geometries with a variety of metal atoms bridging the inorganic linkers. H₂ molecules can adsorb much more strongly in MIFs than they do in typical MOFs. Therefore, ambient and near-ambient storage of H₂ can be achieved in MIFs.

A. Carbon-Free MIFs

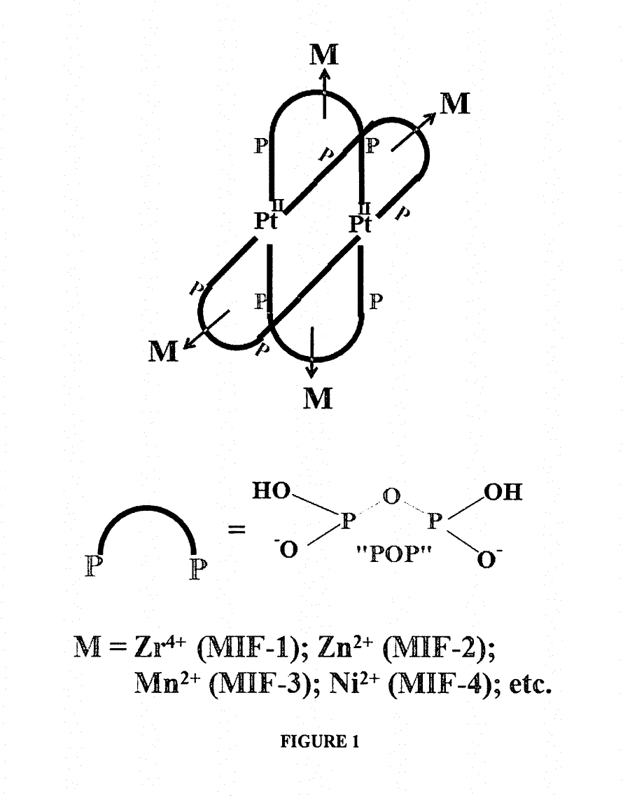

A carbon-free MIF series is depicted in FIG. 1. The carbon-free MIFs are synthesized by a metathesis reaction that replaces the cation from a non-coordinating counter-ion such as Na⁺ or K⁺ in Na₄[Pt₂(P₂O₅H₂)].2H₂O (sodium dihydrotetrakis (pyrophosphito) platinum(II), “NaPtPOP”) or K₄[Pt₂(P₂O₅H₂)].2H₂O (potassium dihydrotetrakis (pyrophosphito) platinum(II), “KPtPOP”). The MIFs are synthesized using a microwave-assisted procedure (Satumtira, 2012), with a coordinating metal ion such as Zr⁴⁺, Zn²⁺, Mn²⁺, or Ni²⁺, leading to the isolation of representative embodiments MIF-1, MIF-2, MIF-3, and MIF-4, respectively.

B. Methods of Making MIFs

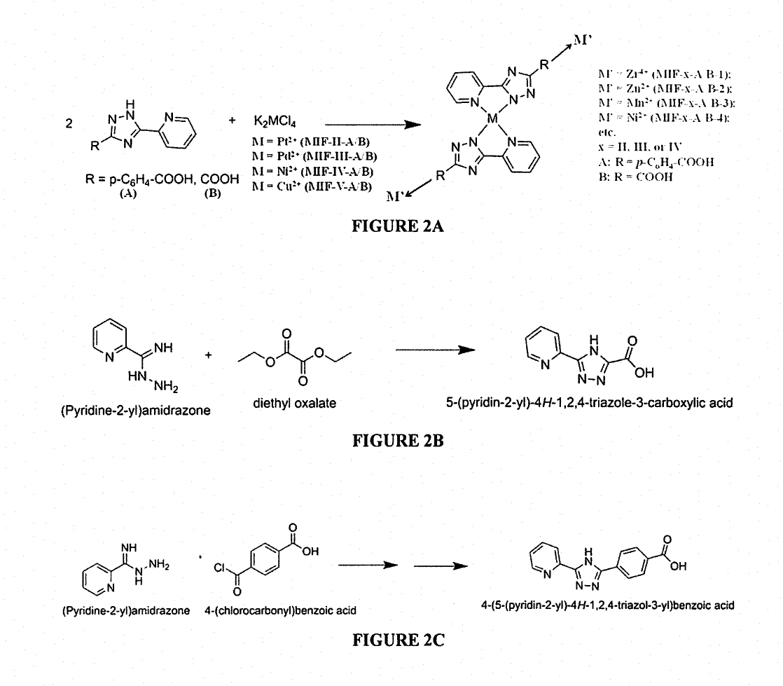

The MIF-II, MIF-III, MIF-IV, and MIF-V series identified in FIG. 2 are synthesized by a novel synthetic scheme. FIG. 2A shows the inorganic synthesis of the building blocks of the MIF-II series (M=Pt²⁺), MIF-III series (M=Pd²⁺), and MIF-IV series (M=Ni²⁺), and MIF-V series (M=Cu²⁺). FIG. 2B shows the synthesis of a ligand that coordinates to the M atoms in the linker with R=COOH. FIG. 2C shows the synthesis of a ligand that coordinates to the M atoms in the linker with R p-C₆H₄COOH. Subsequent coordination of the inorganic linkers to coordinating metal ions (M′) such as Zr⁴⁺, Zn²⁺, Mn²⁺, or Ni²⁺leads to the isolation of representative embodiments MIF-x-A/B-1, MIF-x-A/B-2, MIF-x-A/B-3, and MIF-x-A/B-4, respectively, e.g., “MIF-V-A-3” denotes the sub-series with M=Cu²⁺, R=p-C₆H₄COOH, and M′=Mn²⁺.

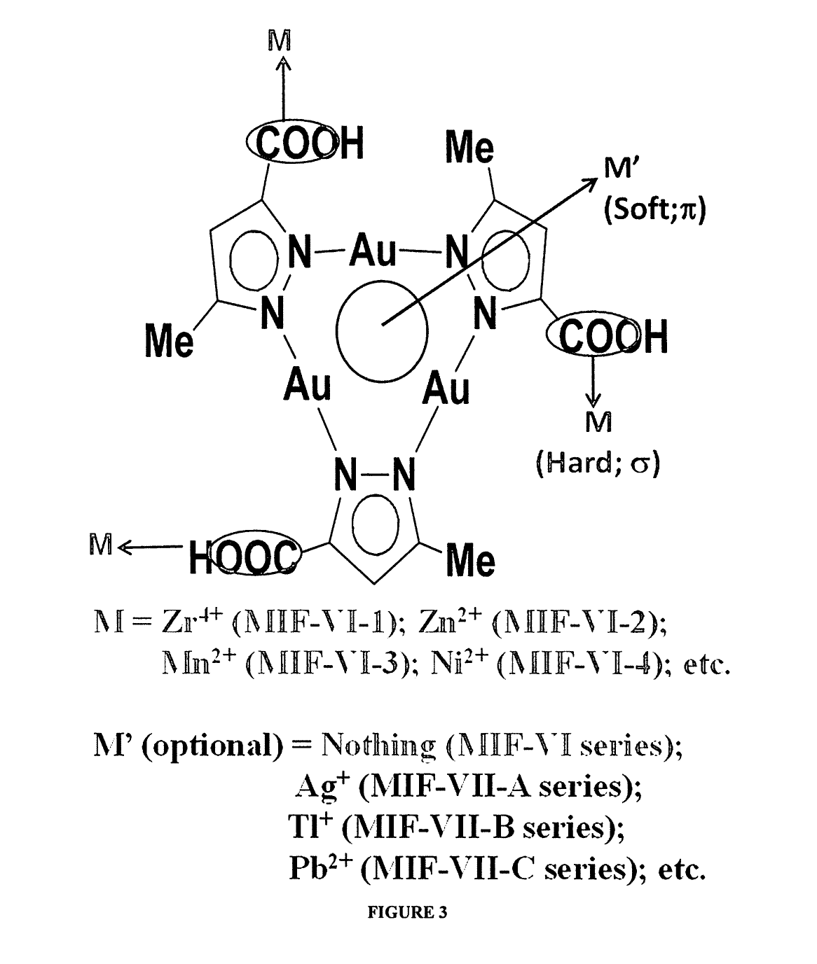

The MIF-VI and MIF-VII series shown in FIG. 3 are synthesized by a metathesis reaction that replaces the acidic COOH protons in the cyclic trinuclear gold(I) complex starting material. The MIF-V and MIF-VI series were synthesized using a previously published procedure (Upadhyay, 2015), with a coordinating, hard, metal ion (M) such as Zr⁴⁺, Zn²⁺, Mn²⁺, or Ni²⁺, leading to the isolation of representative embodiments MIF-x-1, MIF-x-2, MIF-x-3, and MIF-x-4, respectively, with x=VI (MIF-VI series without a second coordinating, soft, M′ metal ion), VII-A (MIF-VII-A series in the presence of a second coordinating, soft, M′ metal ion=Ag⁺), VII-B (MIF-VII-B series in the presence of a second coordinating, soft, M′ metal ion=T1⁺), or VII-C (MIF-VII-C series in the presence of a second coordinating, soft, M′ metal ion=Pb²⁺).

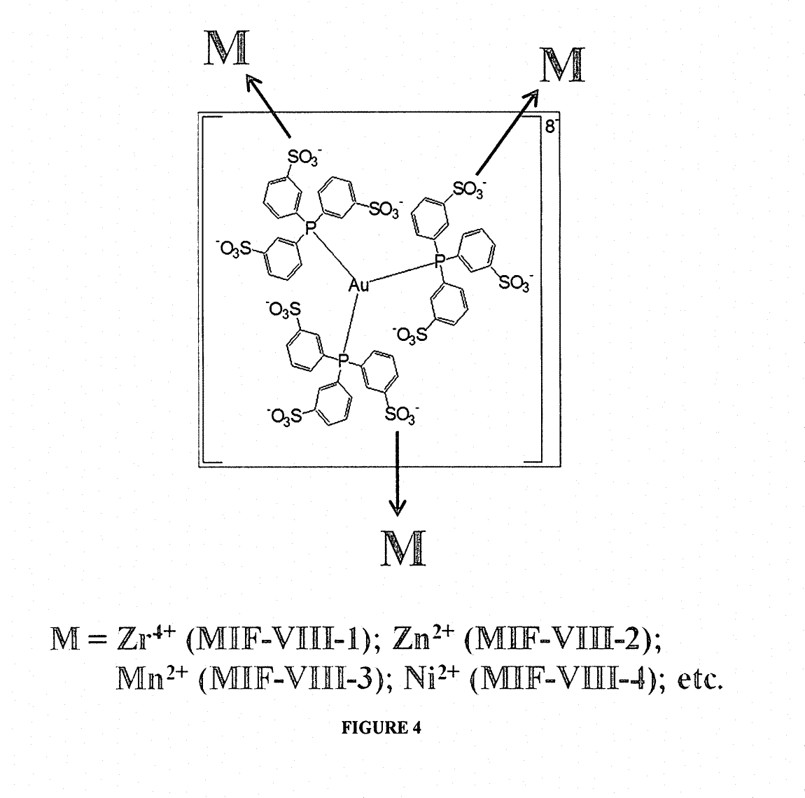

The MIF-VII series shown in FIG. 4 were synthesized by a metathesis reaction to replace the cation from a non-coordinating counter-ion such as Na⁺ in Na₈[Au(TPPTS)₃].2H₂O (sodium tris(tris[3,3′,3″-trisulfonatophenyl]phosphine)aurate(I), which was synthesized following a published procedure (Marpu et al., 2010), with a coordinating metal ion such as Zr⁴⁺, Zn²⁺, Mn²⁺, or Ni²⁺, leading to the isolation of representative embodiments MIF-VIII-1, MIF-VIII-2, MIF-VIII-3, and MIF-VIII-4, respectively.

C. Applications

In contrast to the MOFs described above, the MIFs disclosed herein possess a variety of low-dimensional (linear, trigonal-planar, square-planar, macrocyclic-planar, oligomeric clusters of all the above, and 2-dimensional infinite-sheet assemblies of all the above) geometries with a variety of metal atoms within the inorganic linker. One advantage of the presently claimed MIFs is that they can absorb H₂ molecules can adsorb much more strongly typical MOFs. Therefore, ambient and near-ambient storage of H₂ can be achieved in MIFs.

D. Examples

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Example 1

Nitrogen Adsportion Isotherms

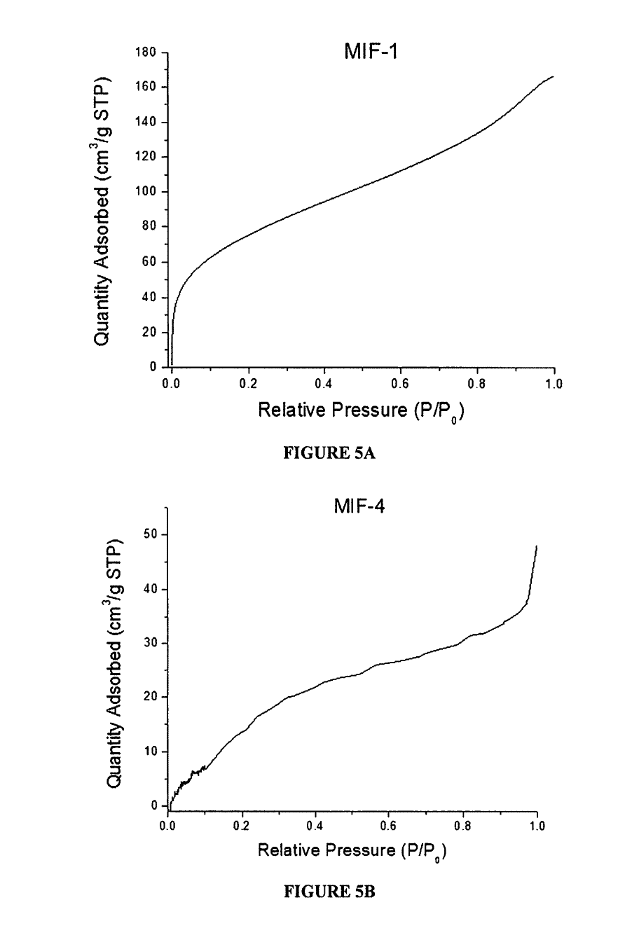

Nitrogen adsorption isotherms at 77 K, shown in FIG. 5, reveal that MIF-1 and MIF-4 are porous with a BET surface area of at least 266.5 m²/g and 86.3 m²/g, respectively; the approximate pore size of MIF-1 was 10 Å, whereas MIF-2 and MIF-3 attained lower porosity parameters. These results validate the concept of attaining permanent porosity in this series of carbon-free MIFs and demonstrate that the extent of porosity can be tuned with the alteration of the coordinating ion to the linker. Optimization of the activation process to remove water/solvent molecules improves the aforementioned lower limits prior to investigating the gas uptake of H₂, CH₄, and other gases and guest species at variable pressure, temperature, and other experimental conditions relevant to different applications.

Example 2

Optical Properties and Shelf-Life Enhancement

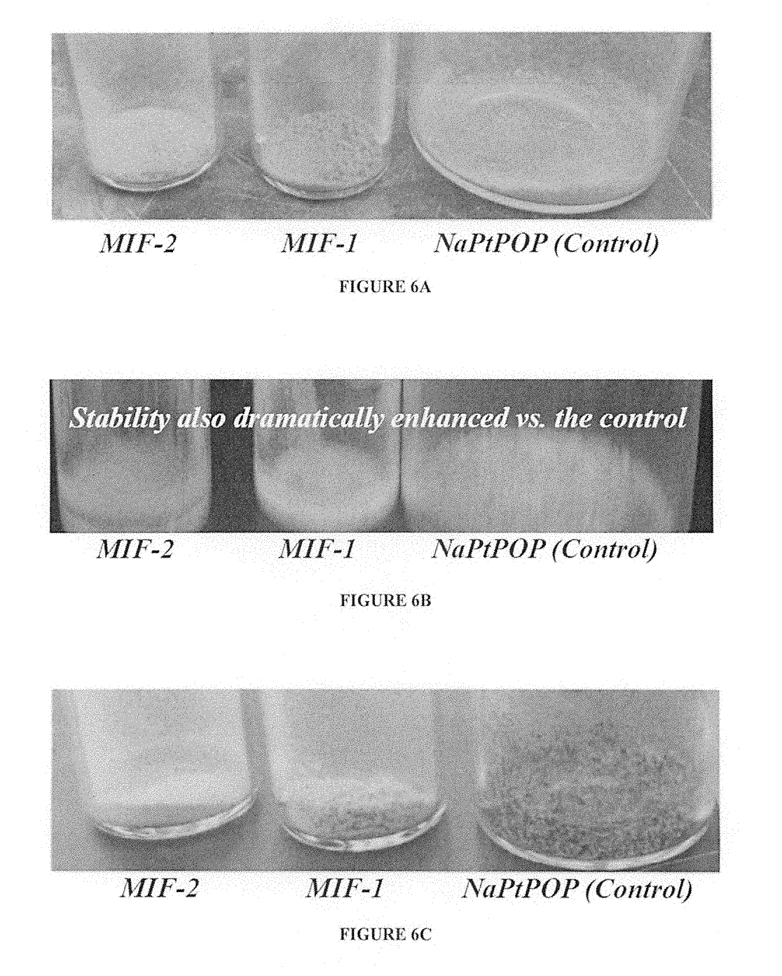

The MIF formation mechanism gives rise to dramatic enhancement in the photoluminescence quantum yield (Φ) and shelf-life (stability upon extended storage in air) for MIF-1 and MIF-2 vs the NaPtPOP starting material/precursor as a control. As illustrated in FIG. 6B, >1000% enhancement in CD was attained for MIF-I, whereas a >600% enhancement was attained for MIF-2.

The shelf-life improved dramatically as evidenced by visual inspection of all MIF samples that maintained their original color even upon multiple months of exposure to storage under ambient air/light/moisture conditions, whereas the NaPtPOP control sample has undergone rather clear discoloration indicating its decomposition under the same storage conditions. Compare appearance of original samples (FIG. 6A) to samples after multiple months of exposure to ambient air/light/moisture conditions (FIG. 6C). Exposed MIF-1 and MIF-2 resemble original samples MIF-1 and MIF-2 in appearance. The appearance of exposed NaPtPOP control sample is significantly different from the original NaPtPOP control sample, indicating that some decomposition has occurred.

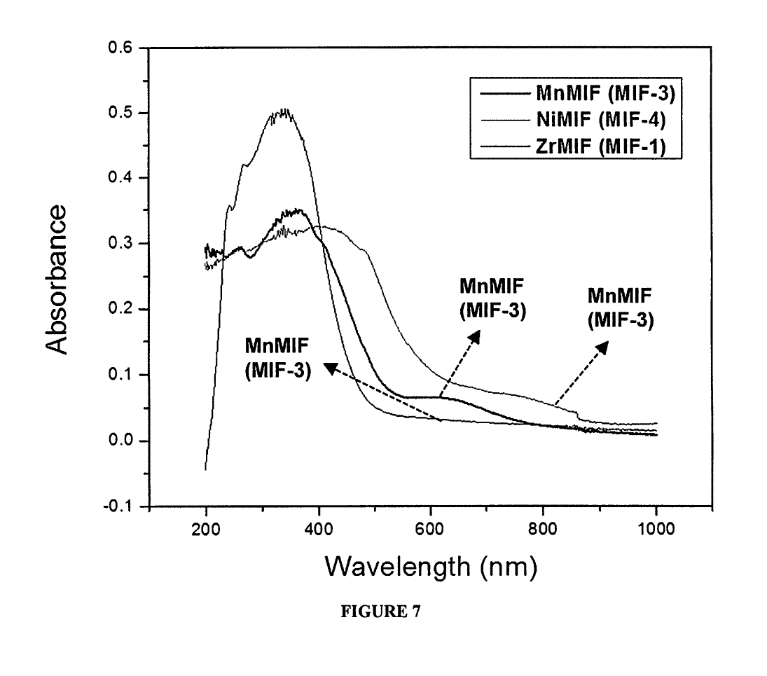

Another manifestation of the sensitivity of the photoluminescence properties of the MIF series to chemical composition is the quenching of the photoluminescence in the presence of paramagnetic ions such as Mn²⁺(d⁵) and Ni²⁺(d⁸), leading to non-luminescent MIF-3 and MIF-4 solids, unlike the situation for the MIF-1 and MIF-2 frameworks that contain diamagnetic Zr⁴⁺⁾(d⁰) and Zn²⁺ (d¹⁰) metal ions, respectively. These differences are illustrated in the solid-state absorption spectra for MIF-3 and MIF-4 vs MIF-1, as shown in FIG. 7. Thus, the weak features at long wavelengths for MIF-3 and MIF-4 are due to dd ligand-field transitions responsible for the quenching of their photoluminescence, whereas these features are absent in MIF-1. By contrast, the sharp signal decline at short wavelengths in MIF-1 is due to its strong photoluminescence, whereas this decline is absent in the non-luminescent MIF-3 and MIF-4 solid samples.

1. A metal-inorganic framework (MIF) coordination polymer comprising:
a plurality of metal clusters, each metal cluster comprising one or more metal ions; and
a plurality of linking complexes connecting adjacent metal clusters.

2. The MIF of claim 1, wherein the one or more metal ions comprises Zr⁴⁺, Zn²⁺, Ni²⁺, Mn²⁺, or a combination thereof.

3. The MIF of claim 1, wherein the linking complexes are linear/two-coordinate, trigonal planar/three-coordinate, or square planar/four-coordinate, or combinations thereof.

4. The linking complexes of claim 3, wherein the linking complexes are oligomeric or polymeric associative linker aggregates.

5. The MIF of claim 1, wherein the metal-inorganic framework comprises a [Pt₂(P₂O₅H₂)]⁴⁻ dimeric 4-coordinate/square planar complex linker.

6. The MIF of claim 1, wherein the metal-inorganic framework comprises a trinuclear gold(I) 2-coordinate/linear complex linker.

7. The MIF of claim 1, wherein the metal-inorganic framework comprises a [Au(TPPTS)₃]⁸⁻ 3-coordinate/trigonal planar complex linker.

8. The MIF of claim 1, wherein the MIF is carbon-free.

9. The MIF of claim 1, wherein the MIF has one or more cavities suitable for containing one or more gas molecules.

10. The MIF of claim 1, wherein the MIF has an average pore size of about 10 Å.

11. The MIF of claim 1, wherein the MIF has a pore volume of 0.13 cm³/g.

12. The MIF of claim 1, wherein the MIF has a maximum pore volume of 0.1325 cm³/g.

13. The MIF of claim 1, wherein the MIF has a surface area of at least about 80 m²/g as measured by the BET method.

14. A method of storing a gas within a metal-inorganic framework (MIF) comprising:
contacting a MIF having an average pore size of 10 Å with a gas;
wherein the gas is at a pressure ranging from 14.5 to 725 psi.

15. The method of claim 14, wherein the MIF comprises a [Pt₂(P₂O₅H₂)]⁴⁻ dimeric four-coordinate/square planar complex linker.

16. The method of claim 14, wherein the MIF comprises a trinuclear gold(I) two-coordinate/linear complex linker.

17. The method of claim 14, wherein the MIF comprises a [Au(TPPTS)₃]⁸⁻ three-coordinate/trigonal planar complex linker.

18. The method of claim 14, wherein the MIF is carbon-free.

19. The method of claim 14, wherein the gas is hydrogen, carbon monoxide, carbon dioxide, a hydrocarbon, nitrogen, oxygen, ammonia, chlorine, a noble gas, hydrogen sulfide, or a solvent vapor.

20. The method of claim 14, wherein said step of contacting the MIF having an average pore size of 10 Å with a gas is performed at a temperature ranging from 50 to 85 Kelvin.
